(19) United States
(12) Patent Application Publication
(10) Pub. No.: US 2012/0206110 A1
(43) Pub. Date: Aug. 16, 2012

(54) REVERSE CURRENT PREVENTION CIRCUIT, CHARGING CIRCUIT INCORPORATING REVERSE CURRENT PREVENTION CIRCUIT, AND CONSTANT-VOLTAGE CIRCUIT INCORPORATING REVERSE CURRENT PREVENTION CIRCUIT

(75) Inventor: Junji NISHIDA, Osaka (JP)

(73) Assignee: RICOH COMPANY, LTD., Tokyo (JP)

(21) Appl. No.: 13/358,698

(22) Filed: Jan. 26, 2012

(30) Foreign Application Priority Data
Feb. 15, 2011 (JP) 2011-029624

(51) Int. Cl. H02H 3/18; G05F 1/10; H02J 7/00

(52) U.S. Cl. 320/163; 361/82; 320/162; 323/265

(57) ABSTRACT

A reverse current prevention circuit, connected to an input terminal, an output terminal, and a driver transistor, including a current detection circuit to detect a current flowing through the driver transistor, and convert the detected current into a detection voltage; a proportional voltage generator to generate a proportional voltage proportional to a difference voltage between an input voltage at the input terminal and an output voltage at the output terminal; an inversely-proportional voltage generator to generate an inversely-proportional voltage inversely proportional to the difference voltage between the input voltage and the output voltage; and a comparison circuit to compares the generated voltages. When the detection voltage, the proportional voltage, and the inversely-proportional voltage are equal, the comparison circuit determines that the indication of the reverse current is detected and prevents the reverse current flowing from the output terminal to the input terminal.

### CROSS-REFERENCE TO RELATED APPLICATION

This patent application is based on and claims priority pursuant to 35 U.S.C. §119 to Japanese Patent Application No. 2011-029624, filed on Feb. 15, 2011 in the Japan Patent Office, the entire disclosure of which is hereby incorporated by reference herein.

### BACKGROUND

1. Technical Field

The present disclosure relates to a reverse current prevention circuit, a charging circuit having a reverse current detection capability, and a constant-voltage circuit such as series regulator having a reverse current detection capability. More particularly, the present disclosure relates to a reverse current prevention circuit that prevents generation of a reverse current from a battery or a load even when an input voltage is decreased, and a charging circuit and a constant-voltage circuit incorporating the reverse current prevention circuit.

2. Description of the Related Art

In a technique proposed in JP-H08-251818-A, a reverse current prevention circuit detects generation of a reverse current during charging of a battery by connecting a switching element and a resistor in series between an input power source and the battery to monitor a charging current to the battery from a charging circuit and comparing voltages across the resistor.

However, in this example, it is necessary to connect the resistor in series with the switching element to detect the generation of the reverse current, thereby inevitably causing the resistor to be impaired. In a case in which a low-resistance resistor is used, it is necessary to provide a comparator whose accuracy is high, which increases cost.

Alternatively, in another technique proposed in JP-2008-228416-A, when a reverse current prevention circuit detects that a charging current in the charging circuit used to charge a battery falls below a preset current value, a reverse current prevention switch that prevents a reverse current from the battery using an oscillation circuit is opened and closed in a predetermined cycle. The reverse current is detected by detecting a decrease in an input voltage when the reverse current prevention switch is off

However, in this example, in the reverse current detection cycle, the reverse current prevention circuit compares the decrease in the input voltage with a preset predetermined voltage and determines that a reverse current is being generated when the decreased input voltage is lower than that preset value. Therefore, in a case in which the output of the power source fluctuates, such as with solar power, generation of the reverse current cannot be detected accurately.

The above-described problems may also occur in constant-voltage circuits constituting series regulators.

### BRIEF SUMMARY

In one aspect of this disclosure, there is provided a reverse current prevention circuit connected to an input terminal, an output terminal, and a driver transistor. The reverse current prevention circuit includes a current detection circuit, a proportional voltage generator, an inversely-proportional voltage generator, and a comparison circuit. The current detection circuit detects a current flowing through the driver transistor and converts the detected current into a voltage for output it as a detection voltage. The proportional voltage generator generates a proportional voltage proportional to a difference voltage between an input voltage at the input terminal and an output voltage at the output terminal The inversely-proportional voltage generator generates an inversely-proportional voltage inversely proportional to the difference voltage between the input voltage and the output voltage. The comparison circuit compares the detection voltage, the proportional voltage, and the inversely-proportional voltage, detects an indication of a reverse current in accordance with comparison result, and generates a reverse current detection signal indicating whether the indication of the reverse current is detected or not. When the detection voltage, the proportional voltage, and the inversely-proportional voltage are equal, the comparison circuit determines that the indication of the reverse current is detected and prevents the reverse current flowing from the output terminal to the input terminal.

In another aspect of this disclosure, there is provided a charging circuit connected to a secondary battery, to charge the secondary battery from a power source. The charging circuit includes an input terminal, an output terminal, a driver transistor, the above-described reverse current prevention circuit, and a charge control circuit. An input voltage from a power source is supplied to the input terminal, and an output voltage is output from the output terminal to the secondary battery. The driver transistor flows a current, controlled by a control signal, from the input voltage to the output voltage. The charge control circuit generates the control signal to control operation of the driver transistor and control charging of the secondary battery.

In yet another aspect of this disclosure, there is provided a constant-voltage circuit to convert an input voltage into an output voltage to a load to keep the output voltage at predetermined constant value. The constant-voltage circuit includes the input terminal, the output terminal, the driver transistor, the above-described reverse current prevention circuit, and a control circuit. The control circuit generates the control signal and control operation of the driver transistor to keep the output voltage at a predetermined constant value.

### BRIEF DESCRIPTION OF THE DRAWINGS

The aforementioned and other aspects, features, aspects, and advantages will be better understood by reference to the following detailed description when considered in connection with the accompanying drawings, wherein:

FIG. 1 is a circuit diagram illustrating a configuration a charging circuit employing a reverse current prevention circuit according to a first embodiment;

FIG. 2 is a graph illustrating an operation example of voltages in the reverse current prevention circuit shown in FIG. 1;

FIG. 3 is a circuit diagram illustrating a constant-voltage circuit, constituted by a series regulator, employing the reverse current prevention circuit shown in FIG. 1;

FIG. 4 is a circuit diagram illustrating a charging circuit employing a reverse current prevention circuit according to a second embodiment; and

FIG. 5 is a circuit diagram illustrating a constant-voltage circuit, constituted by a series regulator, employing the reverse current prevention circuit shown in FIG. 4.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

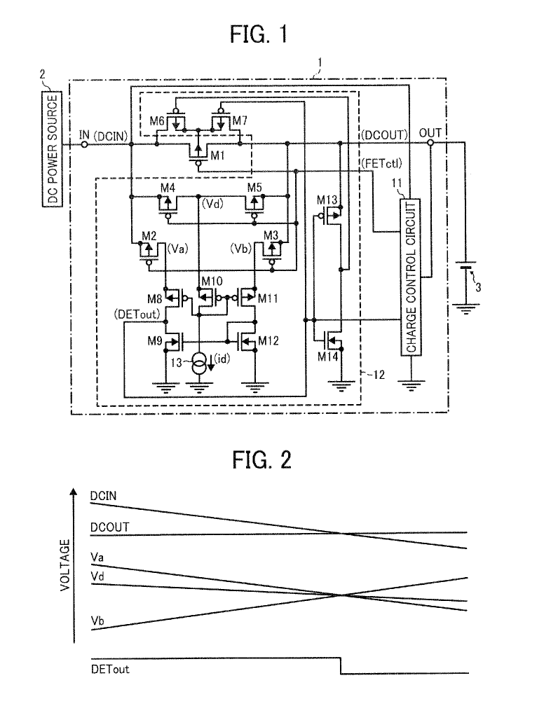

Referring now to the drawings, wherein like reference numerals designate identical or corresponding parts throughout the several views, particularly to FIGS. 1 through 5, reverse current prevention circuits according to illustrative embodiments are described.

### First Embodiment

FIG. 1 is a circuit diagram illustrating a charging circuit employing a reverse current prevention circuit according to a first embodiment. In FIG. 1, a charging circuit 1 charges a secondary battery 3 connected to an output terminal OUT, using an input voltage DCIN input from a direct-current (DC) power source 2 such as a solar cell via an input terminal IN.

The charging circuit 1 includes a driver transistor M1 constituted by a positive-channel metal oxide semiconductor (PMOS) transistor, a charge control circuit 11, and a reverse current prevention circuit 12. The charge control circuit 11 detects an output voltage DCOUT output from the output terminal OUT to control operation of the driver transistor M1 in accordance with the detected output voltage DCOUT and charges the secondary battery 3, using predetermine charging method, such as constant-current charge or constant-voltage charge. The reverse current prevention circuit 12 prevents generation of a reverse current flowing from the output terminal OUT to the input terminal IN caused by decreasing the input voltage DCIN. The reverse current prevention circuit 12 includes PMOS transistors M2 through M8, M10, M11, and M13, negative-channel MOS (NMOS) transistors M9, M12, and M14, and a constant current source 13 to generate a predetermined constant current id.

Herein, the PMOS transistors M4 and M5 function as a current detection circuit, the PMOS transistor M2 functions as a proportional voltage generator, and the PMOS transistor M3 functions an inversely-proportional voltage generator. The PMOS transistors M6, M7, M8, M10, M11, and M13, the NMOS transistors M9, M12, and M14, and the constant current source 13 function as a comparison circuit. Further, the PMOS transistor M4 serves as a first transistor, the PMOS transistor M5 serves as a second transistor, the PMOS transistor M2 serves as a third transistor, the PMOS transistor M3 serves as a fourth transistor, the PMOS transistor M10 serves as a fifth transistor, the PMOS transistor M8 serves as a sixth transistor, and the PMOS transistor M11 serves as a seventh transistor. The PMOS transistors M6, M7, and M13, and the NMOS transistor M14 function as a switch circuit.

The reverse current prevention circuit 12 may be mounted on a single integrated circuit, or alternatively, the charging circuit 1 may be mounted on a single integrated circuit. Yet alternatively, the charging circuit 1 except the driver transistor M1 may be mounted on the single integrated circuit.

The driver transistor M1 is connected between the input terminal IN and the output terminal OUT, and a control signal FETctl from the charge control circuit 11 is input to a gate of the driver transistor M1.

The PMOS transistors M2 and M8 and the NMOS transistor M9 are connected in series between the input voltage DCIN and a ground voltage. The PMOS transistors M3 and M11 and the NMOS transistor M12 are connected in series between the output voltage DCOUT and the ground voltage. Gates of the PMOS transistors M2 and M3 are connected each other, whose junction node is connected to the gate of the driver transistor M1. Herein, drains of the respective transistor serve as input electrodes, sources thereof serve as output electrodes, and gates thereof serve as control electrode.

The NMOS transistors M9 and M12 constitute a current mirror circuit. More specifically, respective sources of the NMOS transistors M9 and M12 are connected to the ground voltage, respective gates thereof are connected to each other, and a junction node between the gates thereof is connected to a drain of the NMOS transistor M12. The NMOS transistor M12 serves as an input transistor, the NMOS transistor M9 serves as an output transistor of the current mirror circuit. A source of the NMOS transistor M12 serves as a current input terminal, and a source of the NMOS transistor M9 serves as a current output terminal A reverse current detection signal DETout is output (generated) from a junction node between the PMOS transistor M8 and the NMOS transistor M9.

In addition, the PMOS transistors M4 and M5 connected in series are connected in parallel to the driver transistor M1. Respective gates of the PMOS transistors M4 and M5 are connected to the gate of the driver transistor M1. The PMOS transistor M10 and the constant current source 13 are connected in series between the ground voltage and a junction node between the PMOS transistors M4 and M5. Respective gates of the PMOS transistors M8, M10, and M11 are connected, whose junction node is connected to a drain of the PMOS transistor M10. Therefore, the fifth transistor M10 supplies a current proportional to the constant current id to the junction node between the first transistor M4 and the second transistor M5, the sixth transistor M8 supplies the current proportional to the constant current id to the source (output electrode) of the third transistor M2, and the seventh transistor M11 supplies the current proportional to the constant current id to the source (output electrode) of the fourth transistor M3.

The PMOS transistor M13 and the NMOS transistor M14 constitute an inverter circuit. More specifically, the PMOS transistor M13 and the NMOS transistor M14 are connected in series between the output voltage DCOUT and the ground voltage. The reverse current detection signal DETout is input to the respective gates of the PMOS transistor M13 and the NMOS transistor M14.

The PMOS transistors M6 and M7 connected in series are connected in parallel to the driver transistor M1. A junction node between the PMOS transistors M6 and M7 is connected to a substrate gate of the driver transistor M1 and substrate gates of the PMOS transistors M6 and M7. A gate of the PMOS transistor M6 is connected to a junction node between the PMOS transistor M13 and the NMOS transistor M14. The reverse current detection signal DETout is input to a gate of the PMOS transistor M7.

The PMOS transistors M6, M7, and M13, and the NMOS transistor M14 function as the switch circuit that is connected to the substrate gate of the driver transistor M1, a junction node between a drain of the driver transistor M1 and the input terminal IN, a junction node between a source of the driver transistor M1 and the output terminal OUT, and a junction node between the source (output electrode) of the sixth transistor M8 and the current output terminal of the current mirror circuit. The switching circuit causes the substrate gate of the driver transistor M1 to connect either the input terminal IN or the output terminal OUT when the reverse current detection signal DETout indicating the indication of the reverse current or the generation of the reverse current is detected so that the reverse current is not generated through the substrate gate of the driver transistor M1.

With this configuration, the input voltage DCIN, the output voltage DCOUT, and the reverse current detection signal DETout are input to the charge control circuit 11, respectively. When the reverse current detection signal DETout indicates that the generation of the reverse current is not detected, the charge control circuit 11 generates the control signal FETctl for output to the gate of the drive transistor M1, in a predetermined way in accordance with the input voltage DCIN and the output voltage DCOUT, and controls a current output from the driver transistor M1.

Conversely, when the reverse current detection signal DETout indicates that either an indication of the reverse current or the generation of the reverse current is detected, the charge control circuit 11 turns the driver transistor M1 off, using the control signal FETctl, to render the driver transistor M1 non-conductive, regardless of the received input voltage DCIN and the output voltage DCOUT.

FIG. 2 is a graph illustrating an operation example of the voltages in the reverse current prevention circuit 12. The operation of the reverse current prevention circuit 12 is described below with reference to FIG. 2. It is to be noted, for ease of explanation and illustration, FIG. 2 shows a case in which the output voltage DCOUT is constant. Herein, transistor sizes of the PMOS transistors M2 and M3 are a fraction of (1/m times) that of the driver transistor M1, for example M is greater than one (m>1), and transistor sizes of the PMOS transistors M4 and M5 are as 2/m times of that of the driver transistor M1. In the other words, current supply capacitances of the third transistor M2 and the fourth transistor M2 are a fraction of that of the driver transistor M1, and the current supply capacitances of the first transistor M4 and the second transistor M5 are twice those of the third transistor M2 and the fourth transistor M3, respectively.

The PMOS transistors M8, M10, and M11 have identical characteristics when the sizes of them are equal. Representing a source voltage of the PMOS transistor M8 as Va, a source voltage of the PMOS transistor M10 as Vd, a source voltage of the PMOS transistor M11 as Vb, and an on resistance of the driver transistor M1 as Ron, following formulas can be obtained. The PMOS transistors M2 through M5 flow the currents therethrough in accordance with the voltage of the control signal FETctl. When the control signal FETctl that commands to turn the driver transistor M1 off is input to the PMOS transistors M2 through M5, the PMOS transistors M2 through M5 are turned off with the driver transistor M1 to render the PMOS transistors M2 through M5 non-conductive.

Herein, the voltage Va serves as a proportional voltage that is proposal to a difference voltage between the input voltage DCIN and the output voltage DCOUT. The voltage Vb serves as an inversely-proportional voltage that is inversely proposal to the difference voltage between the input voltage DCIN and the output voltage DCOUT. The voltage Vd is a voltage converted from a current flowing through the driver transistor M1, serving as a detection voltage indicating a detected value of the current flowing through the driver transistor M1.

More specifically, the current detection circuit (PMOS transistors M4 and M5) detects a current flowing through the driver transistor M1 and converts the detected current into a voltage for output it as the detection voltage Vd. The proportional voltage generator (PMOS transistor M2) generates the proportional voltage Va proportional to the difference voltage between the input voltage DCIN at the input terminal IN and the output voltage DCOUT at the output terminal OUT. The inversely-proportional voltage generator (PMOS transistor M3) generates the inversely-proportional voltage Vb inversely proportional to the difference voltage between the input voltage DCIN and the output voltage DCOUT.

Since the PMOS transistors M4 and M5 are equal size, the detection voltage Vd can be obtained by following formula 1.

Vd=(DCIN+DCOUT)/2 (1)

Representing a current flowing through the PMOS transistor M2 as i2, a current flowing through the PMOS transistor M3 as i3, the proportional voltage Va is calculated by following formula 2, and the inverse-proportional voltage Vb is calculated by following formula 3.

Va=DCIN−Ron/m×i2 (2)

Vb=DCOUT−Ron/m×i3 (3)

Herein, since the reverse current is generated in a case in which the output voltage DCOUT is greater than the input voltage DCIN, a situation in which the input voltage DCIN becomes equal to the output voltage DCOUT indicates the indication of the reverse current.

At this time, the following formulas hold:

Va=Vb=Vd (4)

i2=i3=id (5)

The PMOS transistors M8, M10, and M11, the NMOS transistors M9 and M12, and the constant current source 13 function as the comparison circuit that compares the proportional voltage Va, the inversely-proportional voltage Vb, and the detection voltage Vd. When the detection voltage Vd is smaller than the proportional voltage Va and is greater than the inversely-proportional voltage Vb, that is, when the reverse current is not generated, the comparison circuit outputs a high-leveled reverse current detection signal DETout. Conversely, when the detection voltage Vd is greater than or is equal to the proportional voltage Va and is smaller than or is equal to the inversely-proportional voltage Vb, that is, when the indication of the reverse current or the generation of the reverse current is detected, the comparison circuit outputs a low-leveled reverse current detection signal DETout. The low-leveled current detection signal DETout is a voltage to cause the PMOS transistors to turn off to render the PMOS transistors M8, M10, and M11 non-conductive.

With this operation, the reverse current prevention circuit 12 detects that the current stops flowing through the driver transistor M1, and the input voltage DCIN and the output voltage DCOUT become equal, as the indication of the reverse current.

When the indication of the reverse current is not detected, the reverse current prevention circuit 12 sets the reverse current detection signal DETout at a high level of the voltage that causes the PMOS transistors to turn off to render the PMOS transistors non-conductive. At this time, the charge control circuit 11 controls operation of the driver transistor M1 to charge the secondary battery 3, and turns the PMOS transistor M6 on to render the PMOS transistor M6 conductive and turns the PMOS transistor M7 off to render the PMOS transistor M7 non-conductive.

Conversely, when the reverse current prevention circuit 12 detects that the current stops flowing through the driver transistor M1 and the input voltage DCIN becomes equal to the output voltage DCOUT as the indication of the reverse current, the reverse current prevention circuit 12 changes level of the reverse current detection signal DETout from high to low. At this time, the charge control circuit 11 forcibly turns the driver transistor M1 off to render the driver transistor M1 non-conductive, which stops the charging operation of the secondary battery 3. Along with these processes, the charge control circuit 11 turns the PMOS transistor M6 off to render the PMOS transistor M6 non-conductive and turns the PMOS transistor M7 on to render the PMOS transistor M7 conductive, which prevents the generation of the reverse current through the substrate gate of the driver transistor M1.

### Variation

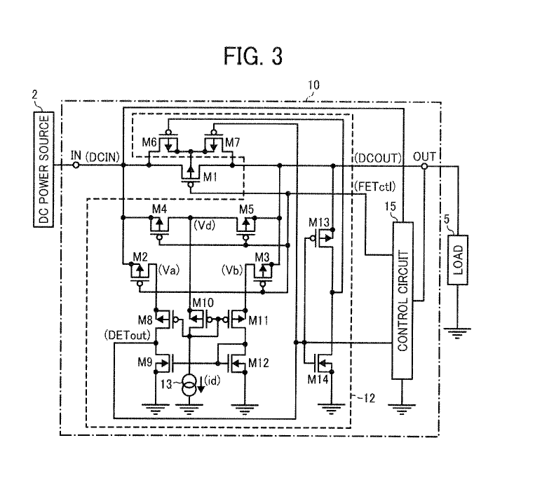

Herein, although the reverse current prevention circuit 12 of the present disclosure is used for the charging circuit 1 in the above-described description shown in FIG. 1, the reverse current prevention circuit 12 may be used for a series regulator shown in FIG. 3. FIG. 3 is a circuit diagram illustrating a constant-voltage circuit 10, constituted by the series regulator, employing the reverse current prevention circuit 12 according to the first embodiment. It is to be noted that, for ease of explanation and illustration, because other than the difference described above the charging circuit 1 shown in FIG. 1 has a configuration similar to the configuration of the constant-voltage circuit 10 shown in FIG. 3, other components of the constant-voltage circuit are represented by identical numerals and the description thereof is omitted below. The difference between the charging circuit 1 and the constant-voltage circuit 10 is that the constant-voltage circuit 10 includes a control circuit 15 instead of the charge control circuit 11 and connects a load 5 instead of the secondary battery 3.

In FIG. 3, the constant-voltage circuit 10, constituted by the series regulator, converts the input voltage DCIN input to the input terminal IN from the DC power source 2 such as the solar cell, into a predetermined voltage for output through the output terminal OUT. More specifically, the constant-voltage circuit 10 controls an output current from the output terminal OUT to adjust the output voltage DCOUT output through the output terminal OUT to a predetermined constant voltage.

The constant-voltage circuit 10 includes the driver transistor M1, the control circuit 15, and the reverse current prevention circuit 12. The control circuit 15 generates a control voltage proportional to the output voltage DCOUT and controls the operation of the driver transistor M1 so that the generated control proportional voltage is set to a predetermined reference voltage.

When the reverse current detection signal DETout is high, for example, the control circuit 15a generates the control voltage proportional to the output voltage DCOUT, compares the control voltage with the predetermined reference voltage, and generates the control signal FETctl in accordance with the difference voltages between the control voltage and the predetermined reference voltage for output to the gate of the driver transistor M1. Thus, the control circuit 15a controls the operation of the driver transistor M1, which can keep the output voltage DCOUT to a desired constant voltage.

Conversely, when the reverse current detection signal DETout becomes low, the control circuit 15 causes forcibly the driver transistor M1 to turn off to render the driver transistor M1 non-conductive, using the control signal FETctl, which stops operation to keep the constant voltage.

The reverse current prevention circuit 12 may be mounted on a single integrated circuit, and alternatively, the constant-voltage circuit 10 may be mounted on a single integrated circuit. Yet alternatively, the constant-voltage circuit 10 except the driver transistor M1 may be mounted on the single integrated circuit.

As described above, in the present embodiment, when the reverse current prevention circuit 12 detects that the current stops flowing through the driver transistor M1 and the input voltage DCIN becomes equal to the output voltage DCOUT, as the indication of the reverse current, the reverse current prevention circuit 12 changes the level of the reverse current detection signal DETout from high to low and prevents the generation of the reverse current through the substrate gate of the driver transistor M1. Accordingly, a circuit, which controls operation of the driver transistor M1 to which the low-leveled reverse current detection signal DETout is input, can forcibly turn the driver transistor M1 off, without a resistor and even when unstable power source, such as the solar cell, is used as the power source 2, both charging circuit 1 and the constant-voltage circuit 10 can prevent the generation of the reverse current with a simple circuit configuration, without detecting mistakenly.

### Second Embodiment

In the above-described first embodiment, when the reverse current prevention circuit 12 detects the indication of the reverse current, the reverse current prevention circuit 12 turns the driver transistor M1 by using the control signal FETctl from either the charge control circuit 11 or the control circuit 15. In a reverse current prevention circuit 12a according to a second embodiment, a PMOS transistor M21, serving as a switching transistor, is added between the driver transistor M1 and the output terminal OUT. When the reverse current prevention circuit 12a according to the present embodiment detects an indication of a reverse current, the reverse current prevention circuit 12a performs a current shutdown operation to shut down the reverse current flowing from the output terminal OUT to the input terminal IN, regardless of the operation of the driver transistor M1. More specifically, at this time, the reverse current prevention circuit 12a causes the PMOS transistor M21 to turn off, using the reverse current detection signal DETout, to render the PMOS transistor M21 non-conductive, which prevents generation of the reverse current.

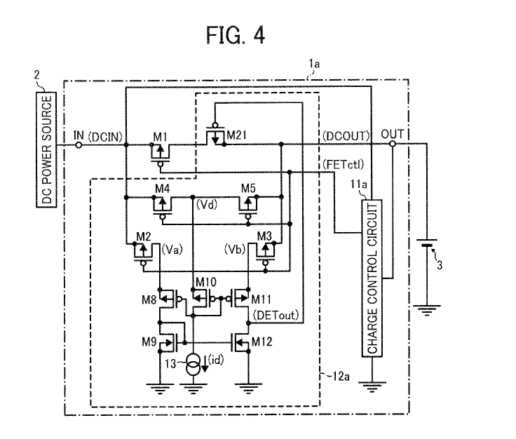

FIG. 4 is a circuit diagram illustrating a charging circuit 1a employing the reverse current prevention circuit 12a according to the second embodiment. It is to be noted that, for ease of explanation and illustration, because other than the difference described above the charging circuit 1 shown in FIG. 1 has a configuration similar to the configuration of the charging device 1a shown in FIG. 4, other components of the charging circuit 1a are represented by identical numerals and the description thereof is omitted below.

The difference between the reverse current prevention circuit 12a shown in FIG. 4 and the reverse current prevention circuit 12 shown in FIG. 1 is described below. In the reverse current detection circuit 12a, the switching transistor M21, constituted by the PMOS transistor is added, and the PMOS transistors M6, M7, and M13 and the NMOS transistor M14 are deleted. In the current mirror circuit formed by the NMOS transistors M9 and M12, input side and output side are changed, that is the NMOS transistor M9 is set to the input side, the NMOS transistor M12 is set to the output side in FIG. 4. The reverse current detection signal DETout is output from a junction node between the PMOS transistor M11 and the NMOS transistor M12. Inputting the reverse current detection signal DETout to the charge control circuit 11 is deleted. With these differences, in FIG. 4, 11a represents the charge control circuit, 12a represents the reverse current prevention circuit, and 1a represents the charging circuit in the present embodiment.

In FIG. 4, the PMOS transistors M8, M10, M11, and M21, the NMOS transistors M9 and M12, and the constant current source 13 function as a comparison circuit. The PMOS transistor M21 serves as the switching transistor (switching element). The reverse current prevention circuit 12a may be mounted on a single integrated circuit, or alternatively, the charging circuit 1a may be mounted on a single integrated circuit. Yet alternatively, the charging circuit 1a except the driver transistor M1 may be mounted on the single integrated circuit.

In FIG. 4, the charging circuit 1a charges the secondary battery 3 connected to the output terminal OUT, using the input voltage DCN to which the voltage in the DC power source 2 such as the solar cell via the input terminal N. The charging circuit 1a includes the driver transistor M1, constituted by a PMOS transistor, the charge control circuit 11a, and the reverse current prevention circuit 12a. The charge control circuit 11a detects the output voltage DCOUT output from the output terminal OUT to control operation of the driver transistor M1 in accordance with the detected output voltage DCOUT and charges the secondary battery 3, using predetermine charging method, such as the constant-current charge or the constant-voltage charge. The reverse current prevention circuit 12a prevents the generation of the reverse current flowing from the output terminal OUT to the input terminal IN caused by decreasing the input voltage DCIN.

The reverse current prevention circuit 12a includes PMOS transistors M2 through M5, M8, M10, M11, and M21, the NMOS transistors M9 and M12, and the constant current source 13 to generate the predetermined constant current id. The PMOS transistor M21 operates as the switching transistor, whose on resistance is enough small to ignore it.

The PMOS transistor M21 is connected between the driver transistor M1 and the output terminal OUT, the reverse current detection signal DETout is input to a gate of the PMOS transistor M21, and a substrate gate of the PMOS transistor M21 is connected to the output voltage DCOUT.

The NMOS transistors M9 and M12 constitute a current mirror circuit. More specifically, respective sources are connected to the ground voltage, and gates thereof are connected each other, the junction node between the gates thereof is connected to the drain of the NMOS transistor M9. The NMOS transistor M9 serves as an input transistor, the NMOS transistor M12 serves as an output transistor of the current mirror circuit. A source of the

NMOS transistor M9 serves as a current input terminal, and a source of the NMOS transistor M12 serves as a current output terminal. The reverse current detection signal DETout is (generated) output from the junction node between the PMOS transistor M11 and the NMOS transistor M12.

The switching element (PMOS transistor M21) is connected in series to the driver transistor M1, connected between the input terminal IN and the output terminal OUT, and connected to a junction node between the source (output electrode) of the seventh transistor M11 and the current output terminal of the current mirror circuit. The reverse current detection signal DETout is input to the gate (control electrode) of the PMOS transistor M21. When the reverse current detection signal DETout indicating that the indication of the reverse current or the generation of the reverse current is detected, the switching element M21 is rendered non-conductive to perform the current shutdown operation to shut down the revere current.

With this configuration, both the input voltage DCIN and the output voltage DCOUT are input to the charge control circuit 11a, and the charge control circuit 11a generates the control signal FETctl in a predetermined way in accordance with the received input voltage DCIN and the output voltage DCOUT, regardless of the reverse current detection signal DETout from the reverse current prevention circuit 12a, to control the current output from the driver transistor M1.

It is to be noted that the graph of the voltage operation in the reverse current prevention circuit 12a is omitted because the voltage operation is similar to the operation shown in FIG. 2 except that the polarity of the reverse current detection signal DETout is inversely to that of the reverse current detection signal DETout in FIG. 2.

The reverse current prevention circuit 12a detects that the current stops flowing through the driver transistor M1 and then the input voltage DCIN and the output voltage DCOUT become equal, as the indication of the reverse current.

When the indication of the reverse current is not detected, the reverse current prevention circuit 12a outputs a low-leveled reverse current detection signal DETout. The low-leveled reverse current detection signal DETout is a voltage in a state in which the PMOS transistor (switching transistor) M21 is turned on and then is rendered conductive state.

Conversely, when the reverse current prevention circuit 12a detects that the current stops flowing through the driver transistor M1 and then the input voltage DCIN and the output voltage DCOUT become equal, as the indication of the reverse current, the reverse current prevention circuit 12a sets the reverse current detection signal DETout at the high level, that is, the reverse current detection signal DETout that causes the PMOS transistor M21 to turn off to render the PMOS transistor non-conductive, which prevents the generation of the reverse current flowing from the output terminal OUT to the input terminal IN.

### Variation

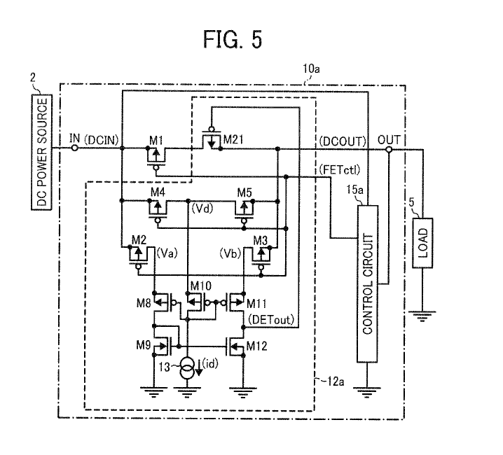

Herein, although the reverse current prevention circuit 12a of the present disclosure is used for the charging circuit 1a in the above-described description shown in FIG. 4, the reverse current prevention circuit 12a may be used for a series regulator shown in FIG. 5. FIG. 5 is a circuit diagram illustrating a constant-voltage circuit 10a, constituted by the series regulator, employing the reverse current prevention circuit 12a according to the second embodiment. It is to be noted that, for ease of explanation and illustration, because other than the difference described above the charging circuit 1a shown in FIG. 4 has a configuration similar to the configuration of the constant-voltage circuit 10a shown in FIG. 5, other components of the constant-voltage circuit 10a are represented by identical numerals and the description thereof is omitted below.

The difference between the charging circuit 1a and the constant-voltage circuit 10a is that the constant-voltage circuit 10a includes a control circuit 15a instead of the charge control circuit 11a and connects the load 5 instead of the secondary battery 3.

In FIG. 5, the constant-voltage circuit 10a, constituted by the series regulator, converts the input voltage DCIN input to the input terminal IN from the DC power source 2, such as the solar cell, into a predetermined voltage for output through the output terminal OUT. More specifically, the constant-voltage circuit 10a controls an output current from the output terminal OUT to adjust the output voltage DCOUT output through the output terminal OUT to a predetermined constant voltage.

The constant-voltage circuit 10a includes the driver transistor M1, the control circuit 15a, and the reverse current prevention circuit 12a. The control circuit 15a generates a voltage (control voltage) proportional to the output voltage DCOUT and controls the operation of the driver transistor M1 so that the control voltage is set to a predetermined reference voltage. For example, regardless of the reverse current detection signal DETout, the control circuit 15a generates the control voltage proportional to the output voltage DCOUT, compares the control voltage with the predetermined reference voltage, and generates the control signal FETctl in accordance with the difference voltages between the control voltage and the predetermined reference voltage for output to the gate of the driver transistor M1. Thus, the control circuit 15a controls the operation of the driver transistor M1, which can keep the output voltage DCOUT to a desired constant voltage.

The reverse current prevention circuit 12a may be mounted on a single integrated circuit, and alternatively, the constant-voltage circuit 10a may be mounted on a single integrated circuit. Yet alternatively, the constant-voltage circuit 10a except the driver transistor M1 may be mounted on the single integrated circuit.

As described above, in the reverse current prevention circuit 12a according to the second embodiment, when the reverse current prevention circuit 12 detects that the current stops flowing through the driver transistor M1 and the input voltage DCIN becomes equal to the output voltage DCOUT as the indication of the reverse current, the reverse current prevention circuit 12a changes the level of the reverse current detection signal DETout from low to high so that the PMOS transistor M21 is turned off to render the PMOS transistor non-conductive, which prevents the generation of the reverse current. Thus, the configuration of the second embodiment can achieve effects similar to those of the reverse current prevention circuit 12 described above.

Furthermore, the reverse current prevention circuit 12a can prevent the generation of the reverse current, independently. Accordingly, the configurations of the respective reverse current prevention circuit 12a and one of the charge control circuit 11 and the control circuit 11 can be more simplified than that of the first embodiment, which can reduce manufacturing cost.

It is to be noted that the type of the transistor and circuit configuration are just examples, the circuits and elements are not limited to the above-described embodiments, and various modifications and improvements in the material and shape of the reverse current prevention circuits are possible without departing from the spirit and scope of the present disclosure. For example, bipolar transistors can be used as the transistors in the reverse current circuits 12 and 12a and the driver transistor of the second embodiment, instead of the MOS transistors. The reverse current prevention circuits according to the present disclosure can be adapted for circuits has a driver transistor to flow the current in accordance with a control signal input to the control electrode from the input terminal to the output terminal.

Numerous additional modifications and variations are possible in light of the above teachings. It is therefore to be understood that, within the scope of the appended claims, the disclosure of this patent specification may be practiced otherwise than as specifically described herein.

What is claimed is:

1. A reverse current prevention circuit, connected to an input terminal, an output terminal, and a driver transistor,
the reverse current prevention circuit comprising:
a current detection circuit to detect a current flowing through the driver transistor, and convert the detected current into a voltage for output it as a detection voltage;
a proportional voltage generator to generate a proportional voltage proportional to a difference voltage between an input voltage at the input terminal and an output voltage at the output terminal;
an inversely-proportional voltage generator to generate an inversely-proportional voltage inversely proportional to the difference voltage between the input voltage and the output voltage; and
a comparison circuit to compare the detection voltage, the proportional voltage, and the inversely-proportional voltage, detect an indication of a reverse current in accordance with comparison result, and generate a reverse current detection signal indicating whether the indication of the reverse current is detected or not,
wherein, when the detection voltage, the proportional voltage, and the inversely-proportional voltage are equal, the comparison circuit determines that the indication of the reverse current is detected and prevents the reverse current flowing from the output terminal to the input terminal.

2. The reverse current prevention circuit according to claim 1, wherein the driver transistor, constituted by a MOS transistor, has a gate to which a control signal is input and transmits the current in accordance with the control signal,
wherein, when the detection voltage, the proportional voltage, and the inversely-proportional voltage are equal, the comparison circuit determines that the indication of the reverse current is detected, outputs a reverse current detection signal indicating that the indication of the reverse current is detected, and causes a substrate gate of the driver transistor to connect either the input terminal or the output terminal so that the reverse current is not generated through the substrate gate of the driver transistor.

3. The reverse current prevention circuit according to claim 2, wherein, when the detection voltage is smaller than the proportional voltage and greater than the inversely-proportional voltage, the comparison circuit determines that the indication of the reverse current is not detected, outputs a reverse current detection signal indicating that the indication of the reverse current is not detected.

4. The reverse current prevention circuit according to claim 2, wherein, when the detection voltage is greater than the proportional voltage and smaller than the inversely-proportional voltage, the comparison circuit determines that the reverse current is generated, outputs a reverse current detection signal indicating that the generation of the reverse current is detected, and causes the substrate gate of the driver transistor to connect either the input terminal or the output terminal so that the reverse current is not generated through the substrate gate of the driver transistor.

5. The reverse current prevention circuit according to claim 2, wherein the current detection circuit comprises a series circuit, connected in parallel to the driver transistor, having a first transistor and a second transistor of identical type and polarity to the first transistor, with control electrodes of the first transistor and the second transistor receiving the control signal that controls operation of the driver transistor, and outputs the detection voltage from a junction node between the first transistor and the second transistor,
the proportional voltage generator comprises a third transistor having an input electrode connected to the input terminal, a control electrode to receive the control signal, and an output electrode to output the proportional voltage, and
the inversely-proportional voltage generator comprises a fourth transistor having an input electrode connected to the output terminal, a control electrode to receive the control signal, and an output electrode to output the inversely-proportional voltage.

6. The reverse current prevention circuit according to claim 5, wherein the comparison circuit comprises:
a constant current source to supply a predetermined constant current;
a fifth transistor having an input electrode connected to the junction node between the first transistor and the second transistor in the current detection circuit, an output electrode connected to the constant current source, and a control electrode connected to the output electrode of the fifth transistor, to supply a current proportional to the constant current to the junction node between the first transistor and the second transistor;
a sixth transistor having an input electrode connected to the output electrode of the third transistor of the proportional voltage generator and a control electrode connected to the control electrode of the fifth transistor, to supply the current proportional to the constant current to the output electrode of the third transistor;
a seventh transistor having a drain connected to the output electrode of the fourth transistor of the inversely-proportional voltage generator and a control electrode connected to the control electrode of the fifth transistor, to supply the current proportional to the constant current to the output electrode of the fourth transistor;
a current mirror circuit having a current input terminal connected to an output electrode of the seventh transistor and a current output terminal connected to an output electrode of the sixth transistor, the current mirror circuit being constituted by an input transistor and an output transistor, and
a switching circuit connected to the substrate gate of the driver transistor, a junction node between a drain of the driver transistor and the input terminal, a junction node between a source of the driver transistor and the output terminal, and a junction node between the output electrode of the sixth transistor and the current output terminal of the current mirror circuit, and
wherein the reverse current detection signal is generated at the junction node between the output electrode of the sixth transistor and the current output terminal of the current mirror circuit for output to the switching circuit, and the switching circuit causes the substrate gate of the driver transistor to connect either the input terminal or the output terminal when the reverse current detection signal indicating the indication of the reverse current or the generation of the reverse current is detected so that the reverse current is not generated through the substrate gate of the driver transistor.

7. The reverse current prevention circuit according to claim 5, wherein current supply capacitances of the third transistor and the fourth transistor are a fraction of that of the driver transistor, and
the current supply capacitances of the first transistor and the second transistor are twice those of the third transistor and the fourth transistor, respectively.

8. The reverse current prevention circuit according to claim 1, wherein, when the detection voltage, the proportional voltage, and the inversely-proportional voltage are equal, the comparison circuit determines that the indication of the reverse current is detected and performs a current shutdown operation to shut down the reverse current flowing from the output terminal to the input terminal

9. The reverse current prevention circuit according to claim 8, wherein, when the detection voltage is smaller than the proportional voltage and greater than the inversely-proportional voltage, the comparison circuit determines that the indication of the reverse current is not detected.

10. The reverse current prevention circuit according to claim 8, wherein, when the detection voltage is greater than the proportional voltage and smaller than the inversely-proportional voltage, the comparison circuit determines that the generation of the reverse current is detected and performs the current shutdown operation to shut down the reverse current flowing from the output terminal to the input terminal

11. The reverse current prevention circuit according to claim 8, wherein the comparison circuit comprises a switching element, connected in series to the driver transistor and connected between the input terminal and the output terminal, to receive the reverse current detection signal,
wherein, when the detection voltage, the proportional voltage, and the inversely-proportional voltage are equal or when the detection voltage is greater than the proportional voltage and smaller than the inversely-proportional voltage, the comparison circuit determines that the indication or generation of the reverse current is detected, and the switching element is rendered non-conductive to perform the current shutdown operation to shut down the reverse current flowing from the output terminal to the input terminal

12. The reverse current prevention circuit according to claim 8, wherein the driver transistor transmits a current in accordance with a control signal input to a control electrode of the driver transistor,
the current detection circuit comprises a series circuit, connected in parallel to the driver transistor, having a first transistor and a second transistor of identical type and polarity to the first transistor, with control electrodes of the first transistor and the second transistor receive the control signal that controls operation of the driver transistor, and outputs the detection voltage from a junction node between the first transistor and the second transistor,
the proportional voltage generator comprises a third transistor having an input electrode connected to the input terminal, a control electrode to receive the control signal, and an output electrode to output the proportional voltage, and
the inversely-proportional voltage generator comprises a fourth transistor having an input electrode connected to the output terminal, a control electrode to receive the control signal, and an output electrode to output the inversely-proportional voltage.

13. The reverse current prevention circuit according to claim 12, wherein the comparison circuit comprises:
a constant current source to supply a predetermined constant current;
a fifth transistor having an input electrode connected to the junction node between the first transistor and the second transistor in the current detection circuit, an output electrode connected to the constant current source, and a control electrode connected to the output electrode of the fifth transistor, to supply a current proportional to the constant current to the junction node between the first transistor and the second transistor;
a sixth transistor having an input electrode connected to the output electrode of the third transistor of the proportional voltage generator and a control electrode connected to the control electrode of the fifth transistor, to supply the current proportional to the constant current to the output electrode of the third transistor;
a seventh transistor having an input electrode connected to the output electrode of the fourth transistor of the inversely-proportional voltage generator and a control electrode connected to the control electrode of the fifth transistor, to supply the current proportional to the constant current to the output electrode of the fourth transistor;
a current mirror circuit having a current input terminal connected to an output electrode of the sixth transistor and a current output terminal connected to an output electrode of the seventh transistor, the current mirror circuit being constituted by an input transistor and an output transistor; and
a switching element connected in series to the driver transistor, connected between the input terminal and the output terminal, and connected to a junction node between the output electrode of the seventh transistor and the current output terminal of the current mirror circuit, and
wherein the reverse current detection signal is generated at the junction node between the output electrode of the seventh transistor and the current output terminal of the current mirror circuit for output to the switching element, and the switching element is rendered non-conductive to perform the current shutdown operation when the reverse current detection signal indicating that the indication of the reverse current or the generation of the reverse current is detected.

14. The reverse current prevention circuit according to claim 13, wherein current supply capacitances of the third transistor and the fourth transistor are respectively a fraction of that of the driver transistor, respectively, and
the current supply capacitances of the first transistor and the second transistor are twice those of the third transistor and the fourth transistor, respectively.

15. A charging circuit connected to a secondary battery, to charge the secondary battery from a power source,
the charging circuit comprising:
an input terminal to which an input voltage from a power source is supplied;
an output terminal from which an output voltage is output to the secondary battery;
a driver transistor to flow a current, controlled by a control signal, from the input voltage to the output voltage;
a reverse current prevention circuit, connected to the input terminal, the output terminal, and the driver transistor:
the reverse current prevention circuit comprising:
a current detection circuit to detect a current flowing through the driver transistor, and convert the detected current into a voltage for output it as a detection voltage;
a proportional voltage generator to generate a proportional voltage proportional to a difference voltage between the input voltage at the input terminal and the output voltage at the output terminal;
an inversely-proportional voltage generator to generate an inversely-proportional voltage inversely proportional to the difference voltage between the input voltage and the output voltage; and
a comparison circuit to compare the detection voltage, the proportional voltage, and the inversely-proportional voltage, detect an indication of a reverse current in accordance with comparison result, and generate a reverse current detection signal indicating whether the indication of the reverse current is detected or not,
wherein, when the detection voltage, the proportional voltage, and the inversely-proportional voltage are equal, the comparison circuit determines that the indication of the reverse current is detected and prevents the reverse current flowing from the output terminal to the input terminal; and
a charge control circuit to generate the control signal to control operation of the driver transistor and control charging of the secondary battery.

16. The charging circuit according to claim 15, wherein, the driver transistor, constituted by a MOS transistor, has a gate to which the control signal is input and transmits the current in accordance with the control signal,
the charge control circuit receives the reverse current detection signal indicating whether the indication of the reverse current and generates the control signal based on the reverse current detection signal,
wherein, when the detection voltage, the proportional voltage, and the inversely-proportional voltage are equal in the reverse current prevention circuit, the comparison circuit determines that the indication of the reverse current is detected, outputs a reverse current detection signal indicating that the indication of the reverse current is detected to the charge control circuit, and causes a substrate gate of the driver transistor to connect either the input terminal or the output terminal so that the reverse current is not generated through the substrate gate of the driver transistor, and
the charge control circuit causes the driver transistor to forcibly turn off to render the driver transistor non-conductive, using the control signal, when the charge control circuit receives the reverse current detection signal indicating that the indication of the reverse current is detected.

17. The charging circuit according to claim 15, wherein, when the detection voltage, the proportional voltage, and the inversely-proportional voltage are equal in the reverse current prevention circuit, the comparison circuit determines that the indication of reverse current is detected and performs a current shutdown operation to shut down the reverse current flowing from the output terminal to the input terminal

18. A constant-voltage circuit to convert an input voltage into an output voltage to a load to keep the output voltage at predetermined constant value;
the constant-voltage circuit comprising:
an input terminal to which the input voltage from a power source is supplied;
an output terminal from which the output voltage is output to the load;
a driver transistor to flow a current, controlled by a control signal, from the input voltage to the output voltage;
a reverse current prevention circuit, connected to the input terminal, the output terminal, and the driver transistor;
the reverse current prevention circuit comprising:
a current detection circuit to detect a current flowing through the driver transistor, and convert the detected current into a voltage for output it as a detection voltage;
a proportional voltage generator to generate a proportional voltage proportional to a difference voltage between the input voltage at the input terminal and the output voltage at the output terminal;
an inversely-proportional voltage generator to generate an inversely-proportional voltage inversely proportional to the difference voltage between the input voltage and the output voltage; and
a comparison circuit to compare the detection voltage, the proportional voltage, and the inversely-proportional voltage, to detect an indication of a reverse current in accordance with comparison result, and generate a reverse current detection signal indicating whether the indication of the reverse current is detected or not,
wherein, when the detection voltage, the proportional voltage, and the inversely-proportional voltage are equal, the comparison circuit determines that the indication of the reverse current is detected, and prevents the reverse current flowing from the output terminal to the input terminal; and
a control circuit to generate the control signal and control operation of the driver transistor to keep the output voltage at a predetermined constant value.

19. The constant-voltage circuit according to claim 18, wherein, the driver transistor, constituted by a MOS transistor, has a gate to which the control signal is input and transmits the current in accordance with the control signal,
the control circuit receives the reverse current detection signal indicating whether the indication of the reverse current and generates the control signal based on the reverse current detection signal,
wherein, when the detection voltage, the proportional voltage, and the inversely-proportional voltage are equal in the reverse current prevention circuit, the comparison circuit determines that the indication of the reverse current is detected, outputs a reverse current detection signal indicating that the indication of the reverse current is detected to the control circuit, and causes a substrate gate of the driver transistor to connect either the input terminal or the output terminal so that the reverse current is not generated through the substrate gate of the driver transistor, and
the control circuit causes the driver transistor to forcibly to turn off to render the driver transistor non-conductive, using the control signal, when the control circuit receives the reverse current detection signal indicating that the indication of the reverse current is detected.

20. The constant-voltage circuit according to claim 18, wherein, when the detection voltage, the proportional voltage, and the inversely-proportional voltage are equal in the reverse current prevention circuit, the comparison circuit determines that the indication of the reverse current is detected and performs a current shutdown operation to shut down the reverse current flowing from the output terminal to the input terminal.
